(19) United States
(12) Patent Application Publication
(10) Pub. No.: US 2020/0134785 A1
(43) Pub. Date: Apr. 30, 2020

(54) REVERSE IMAGE PROCESSING SYSTEM

(71) Applicant: BEIJING WEIBOXINTONG TECHNOLOGY CO., LTD., Beijing (CN)

(72) Inventor: Guohui Hu, Shenzhen (CN)

(21) Appl. No.: 16/731,125

(22) Filed: Dec. 31, 2019

(30) Foreign Application Priority Data
Dec. 30, 2019 (CN) 201911390055.7

(51) Int. Cl. G06T 3/60; G06T 5/00; G06T 5/20; G06T 7/11

(52) U.S. Cl. CPC G06T 3/602; G06T 5/002; G06T 5/20; G06T 2207/20021; G06T 2207/30252; G06T 2207/20212; G06T 7/11

(57) ABSTRACT

The invention provides a reverse image display system. An image blocking module segments a reverse image into visual saliency image blocks and non-visual saliency image blocks according to visual saliency. A denoising module denoises the visual saliency image blocks by a BM3D algorithm, and denoises the non-visual saliency image blocks by a mean filtering algorithm. A composition module composites the denoised visual saliency image blocks and non-visual saliency image blocks into a final required reverse image which is transmitted to an automobile display screen for display. The visual saliency image blocks are denoised by the BM3D algorithm, so that the obtained image is more easily watched by human eyes, and the non-visual saliency image blocks are denoised by the mean filtering algorithm, denoising speed can be increased while certain image quality is maintained, and the denoising speed can be conveniently increased by a computer as a whole.

### FIELD OF THE INVENTION

The invention relates to the technical field of automobiles, in particular to a reverse image processing system.

### BACKGROUND

With popularization of automobiles, automobile reverse images gradually become standard on automobiles. The automobile reverse images can assist drivers in observing the rear situation and avoid accidents. In the prior art, the automobile reverse image processing system usually consists of an image acquisition module, an image processing module and an automobile display screen. A reverse image acquired by the image acquisition module is converted by the image processing module and then transmitted to the automobile display screen for display. However, in the prior art, the image processing module only performs data format conversion on the acquired reverse image, and the original image is directly transmitted to the automobile display screen for display; and how to enhance quality of the reverse image to obtain better display effect is a problem in the industry.

### BRIEF DESCRIPTION OF THE INVENTION

The invention aims to provide a reverse image display system, which can enhance quality of reverse images, facilitate observation of the reverse images for drivers, and improve safety of automobiles.

To achieve the aim, the following technical scheme is adopted:

A reverse image processing system comprises an image acquisition module, an image processing module and an automobile display screen, wherein the image processing module comprises:

A reverse image receiving module, used for receiving a reverse image sent by the image acquisition module;

An image blocking module, used for segmenting the reverse image into visual saliency image blocks and non-visual saliency image blocks according to visual saliency;

A denoising module, used for denoising the visual saliency image blocks by a BM3D algorithm, and denoising the non-visual saliency image blocks by a mean filtering algorithm;

A composition module, used for compositing the denoised visual saliency image blocks and non-visual saliency image blocks into a final required reverse image which is transmitted to an automobile display screen for display.

Compared with the prior art, the reverse image processing system has the following beneficial effects:

The image blocking module segments the reverse image into the visual saliency image blocks and the non-visual saliency image blocks according to visual saliency. The denoising module denoises the visual saliency image blocks by the BM3D algorithm, and denoises the non-visual saliency image blocks by the mean filtering algorithm. The composition module composites the denoised visual saliency image blocks and non-visual saliency image blocks into the final required reverse image which is transmitted to the automobile display screen for display. As the reverse image is segmented into the visual saliency image blocks and the non-visual saliency image blocks and the visual saliency image blocks are denoised by the BM3D algorithm, the obtained image is more easily watched by human eyes, and a driver can conveniently observe a reverse image picture; and the non-visual saliency image blocks are denoised by the mean filtering algorithm, denoising speed can be increased while certain image quality is maintained, and the denoising speed can be conveniently increased by a computer as a whole.

### BRIEF DESCRIPTION OF THE DRAWINGS

FIG. 1 is a diagram of an embodiment of the reverse image processing system;

FIG. 2 is a diagram of an embodiment of the reverse image processing system.

### DETAILED DESCRIPTION

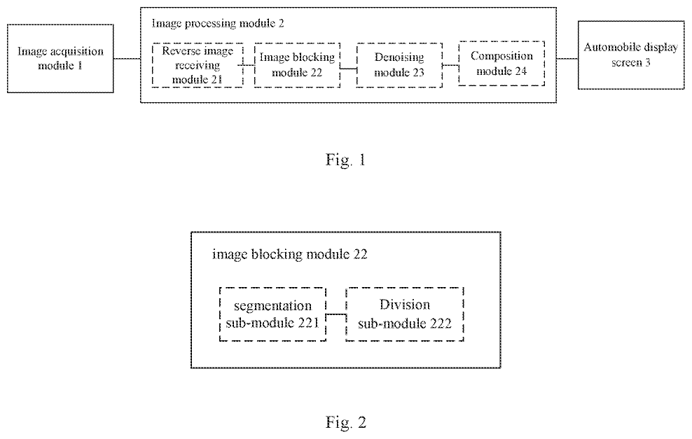

In reference to FIG. 1, the FIG. 1 illustrates a block diagram of a specific embodiment of a reverse image display system, an automobile reverse image display system of the embodiment comprises an image acquisition module 1, an image processing module 2 and an automobile display screen 3, the image processing module 2 specifically comprises:

A reverse image receiving module 21, an image blocking module 22, a denoising module 23 and a composition module 24 are described respectively as follows:

The reverse image receiving module 21 of the embodiment is mainly used for receiving a reverse image sent by the image acquisition module 1;

The image blocking module 22 of the embodiment mainly segments the reverse image into visual saliency image blocks and non-visual saliency image blocks according to visual saliency, during concrete implementations, for example, as a preferred embodiment, in reference to FIG. 2, the image blocking module 22 of the embodiment specifically comprises a segmentation sub-module 221 and a division sub-module 222, wherein:

The segmentation sub-module 221 is used for segmenting the reverse image into different image blocks and calculating a visual saliency parameter value of each image block;

The division sub-module 222 is used for segmenting the image blocks into the visual saliency image blocks and the non-visual saliency image blocks;

It should be noted that during specific implementation, the segmentation sub-module 221 can calculate the visual saliency parameter value of each image block by the RC (region-based contrast) algorithm, other algorithms can also be adopted in practice, and there is no specific limitations:

The denoising module 23 of the embodiment is mainly used for denoising the visual saliency image blocks by the BM3D algorithm and denoising the non-visual saliency image blocks by the mean filtering algorithm;

The composition module 24 of the embodiment is mainly used for compositing the denoised visual saliency image blocks and non-visual saliency image blocks into a final required reverse image which is transmitted to the automobile display screen for display.

In the embodiments, in order to improve the display quality of the reverse image, the image processing module needs to denoise the reverse image, but each part of the reverse image needs different image qualities, for example, for the part caught more attention by human eyes, the requirement for the image quality is high, and for the part caught less attention by human eyes, the requirement for the image quality is low. However, if all parts are denoised, a computer processor needs longer processing time and is low in efficiency, thus, the image blocking module 22 in the embodiments segments the reverse image into the visual saliency image blocks and the non-visual saliency image blocks according to visual saliency. The denoising modules denoises the visual saliency image blocks by the BM3D algorithm, accordingly, the image quality is higher, the processing time is relatively longer, the non-visual saliency image blocks are denoised by the mean filtering algorithm, the image quality is not as good as that obtained by the BM3D algorithm, but the processing time of the computer processor is shorter, finally, the denoised images are composited into the final required reverse image which is transmitted to the automobile display screen for display, and there is no more detailed description.

It should be noted that visual saliency can be measured from multiple parameters, for example, visual saliency can be distinguished from color difference or space distance relation while the visual saliency parameter values can be calculated from color contrast or space distance relation. Specifically, the reverse image is segmented into N*N image blocks, the color contrast is taken as a visual saliency parameter, the color contrast of each image block is calculated, the color contrast value with visual saliency is set as a classification threshold, the color contrast of each image block is compared with the classification threshold of the color contrast, so that the image can be classified as the visual saliency image blocks and the non-visual saliency image blocks. Besides, if space distance is taken as a visual saliency parameter, firstly, the region with visual saliency is determined, further, a space distance value between each image block and the region with the visual saliency are calculated, the space distance value of each image block and the classification threshold of the space distances are compared, the image can also be classified as the visual saliency image blocks and the non-visual saliency image blocks, other visual saliency parameters and algorithms can also be adopted in practice, and there is no specific limitation.

The embodiments are merely preferred embodiments, which are not used for limiting the present invention, any modifications, equivalent replacement and improvement made within the spirit and principle of the present invention shall be included in the protection scope of the present invention.

1. A reverse image processing system comprises an image acquisition module, an image processing module and an automobile display screen, the system is characterized in that the image processing module comprises:
A reverse image receiving module, used for receiving a reverse image sent by the image acquisition and processing module;
An image blocking module, used for segmenting the reverse image into visual saliency image blocks and non-visual saliency image blocks according to visual saliency;
A denoising module, used for denoising the visual saliency image blocks by a BM3D algorithm, and denoising the non-visual saliency image blocks by a mean filtering algorithm;
A composition module, used for compositing the denoised visual saliency image blocks and non-visual saliency image blocks into a final required reverse image which is transmitted to an automobile display screen for display.

2. The system of claim 1, characterized in that the image blocking module specifically comprises:
a segmentation sub-module, used for segmenting the reverse image into different image blocks and calculating visual saliency parameter value of each image block;
A division sub-module, used for dividing the image blocks into the visual saliency image blocks and the non-visual saliency image blocks according to the visual saliency parameter and a visual saliency classification threshold of each image block.

3. The system of claim 2, characterized in that the segmentation sub-module calculates the visual saliency parameter value of each image block by a RC (region-based contrast) algorithm.
